(19) United States
(12) Patent Application Publication
(10) Pub. No.: US 2006/0091849 A1
(43) Pub. Date: May 4, 2006

(54) Modular battery pack

(76) Inventors: Due Q. Huynh, Lawrenceville, GA (US); Ronald R. Torrence, Suwanee, GA (US)

Correspondence Address: MOTOROLA INC, 600 NORTH US HIGHWAY 45, ROOM AS437, LIBERTYVILLE, IL, 60048-5343, US

(21) Appl. No.: 10/980,109

(22) Filed: Nov. 1, 2004

(51) Int. Cl. H02J 7/00

(52) U.S. Cl. 320/112

(57) ABSTRACT

A modular battery pack includes a plurality of battery modules. Each battery module includes a plurality of cells disposed within a cell compartment that is hermetically sealed from a circuit compartment in the battery module. The liquid-impenetrable seal is achieved by insert molding tabs that electrically connect the cell compartment and the circuit compartment. Additionally, the lid of the battery module is ultrasonically welded to the battery module housing. The battery modules are placed into battery module compartments in a main housing, and couple to a main connector by way of a printed circuit board that couples the main connector to battery module connectors on each battery module. The pack ensures that any electrolyte that may leak from a cell does not compromise the electronic circuitry and associated components within the pack. Additionally, the fact that the pack can be separated into modules allows the pack to be shipped in conformity with applicable transportation and safety regulations.

### BACKGROUND

1. Technical Field

This invention relates generally to rechargeable battery packs, and more specifically to a modular battery pack that prevents any liquid electrolyte that may leak from a cell from reaching the electronic circuitry.

2. Background Art

Most portable electronic devices today derive their portability from rechargeable batteries. Countless devices, from cellular telephones to laptop computers, employ rechargeable battery packs for as a power source. One of the most popular rechargeable battery technologies used in portable electronic devices is lithium-ion technology, due in part to its high energy to weight ratio.

Rechargeable battery packs have become so popular that electronic equipment that has traditionally not used rechargeable batteries is now being equipped with rechargeable battery packs. One such piece of equipment is an uninterruptible power supply (UPS). UPS devices are frequently used with data sensitive equipment like computers. The UPS ensures that the computer does not lose data when the primary power source, like the power grid for example, goes down.

The problem associated with using lithium based batteries in UPS applications is that many cells are required to provide the current required by this application. A typical UPS supply may require as many as 45 or more lithium-ion cells. The problem with this quantity of cells is that the US transportation guidelines classify any untested device that uses a battery cell pack with more than 8 grams of aggregate lithium content, which roughly corresponds to 12 18650 lithium-ion cells, as “dangerous goods”. Consequently, a manufacturer desiring to use lithium-ion cells for a UPS must either ship the battery declared as “dangerous goods” at a premium cost, or ship the cells individually in order to reduce the lithium content below the regulated level, and then have a technician reassemble the pack at the customer's location. Each of these processes are both expensive and time consuming.

There is thus a need for an improved, “shipment friendly”, high-capacity battery pack.

### BRIEF DESCRIPTION OF THE DRAWINGS

FIG. 1 illustrates an exploded view of a battery module in accordance with the invention.

FIGS. 2A and 2B illustrate views of the battery module with the housing shown as transparent to illustrate the inner connections of the battery module in accordance with the invention.

FIG. 3 illustrates an exploded view of a modular battery pack in accordance with the invention.

FIG. 4 illustrates a modular battery pack in accordance with the invention.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

This invention is a modular battery pack that utilizes battery modules to divide a plurality of cells into individual, self-contained cell banks. The battery modules are self contained units having a cell compartment and a circuit compartment. The cell compartment has a liquid-impermeable seal with respect to the circuit compartment, such that any liquid (like cell electrolyte) present in the cell compartment can not reach the electronic circuitry. The liquid impermeable seal is primarily formed by insert molding electrical tabs into the housing of the battery modules and by ultrasonically welding the lid to the housing.

Each of the modules fits into a main housing. A main circuit assembly, or printed circuit board, includes a plurality of connectors that can couple to an electrical connector connected to the electronic circuitry of the battery module. The electrical circuitry of each module preferably includes a safety circuit to ensure that the cells are not mischarged. As such, the modular components of the invention may be shipped in compliance with IATA (International Air Transport Association) guidelines. At the customer site, a customer simply snaps the modules together—without the need of a technician—thereby saving both time and cost.

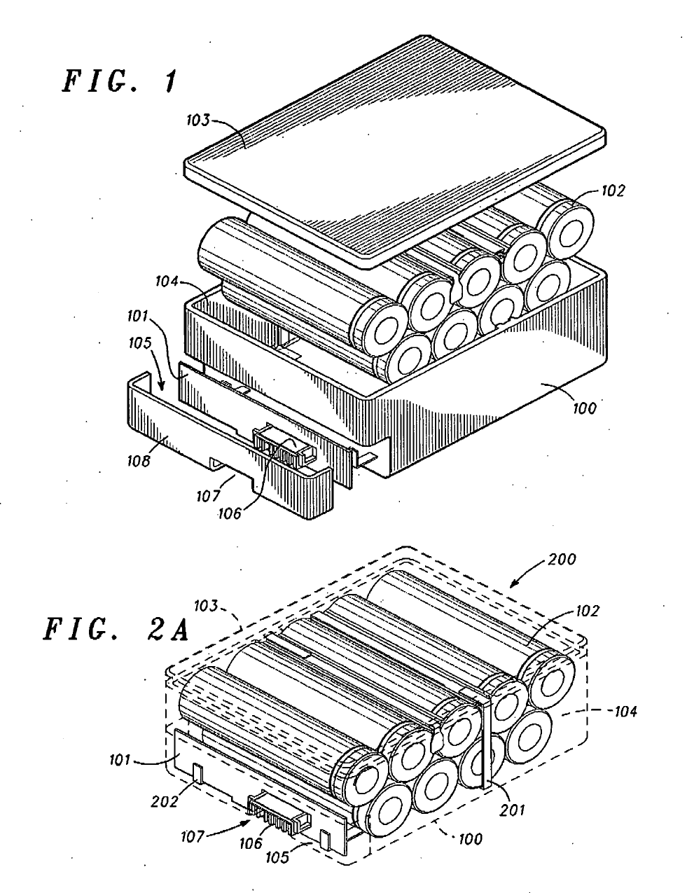

Turning now to FIG. 1, illustrated therein is a view of a battery module in accordance with the invention. FIG. 1 illustrates an exploded view of the battery module housing and internal components.

Each battery module includes a battery module housing 100, preferably made from plastic, having a cell compartment 104 and a circuit compartment 105. A plurality of rechargeable cells 102 is disposed within the cell compartment 104. A battery module circuit assembly 101 is disposed within the circuit compartment 105. A cap 108 fully encloses the circuit compartment 105 to protect the circuit assembly 101 from debris and damage.

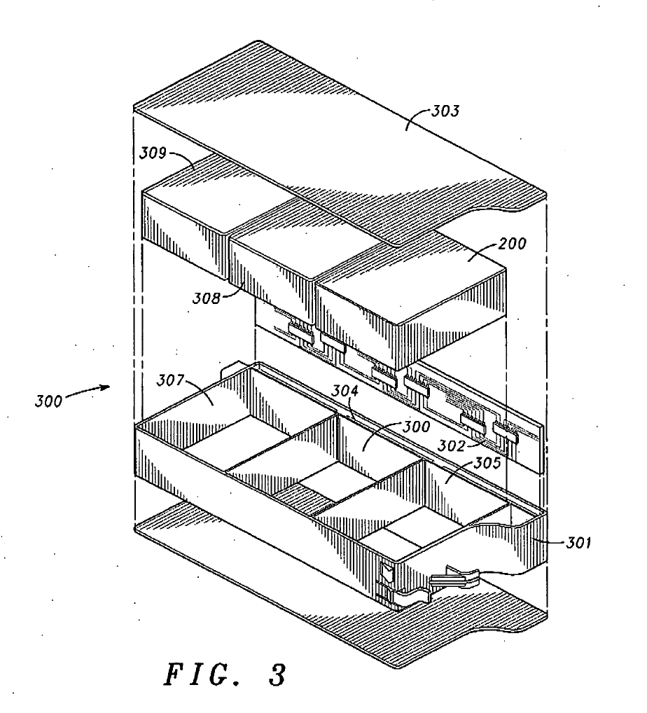

The battery module circuit assembly 101 includes electronic circuitry disposed upon a substrate. The substrate material may be a printed circuit board, or may be a flexible substrate. The electronic circuitry may include a circuit selected from the group consisting of safety circuits, charging circuits and fuel gauging circuits. The battery module circuit assembly 101 includes at least one electrical connector 106 that is capable of connecting to a connector on the main circuit assembly, as will be seen in FIG. 3. The electrical connector 106 is exposed through an aperture 107 in the battery module housing 107.

A lid 103 seals the cells 102 within the battery module housing 100. A cap 108 encloses the battery module circuit assembly 101 within circuit compartment 105. The lid 103 may be coupled to the battery module housing 100 in any of a variety of ways. Preferred methods of attaching the lid 103 to the battery module housing 100 include ultrasonic welding, gluing, snaps and screws. Experimental results have shown that ultrasonic welding works well in that it provides a liquid impermeable seal about the cell compartment 104, so as to prevent any electrolyte that may have leaked from the cells 102 from escaping the cell compartment 104. The cap 108 may be attached to the battery module housing 100 via ultrasonic welding, gluing, snaps, or screws.

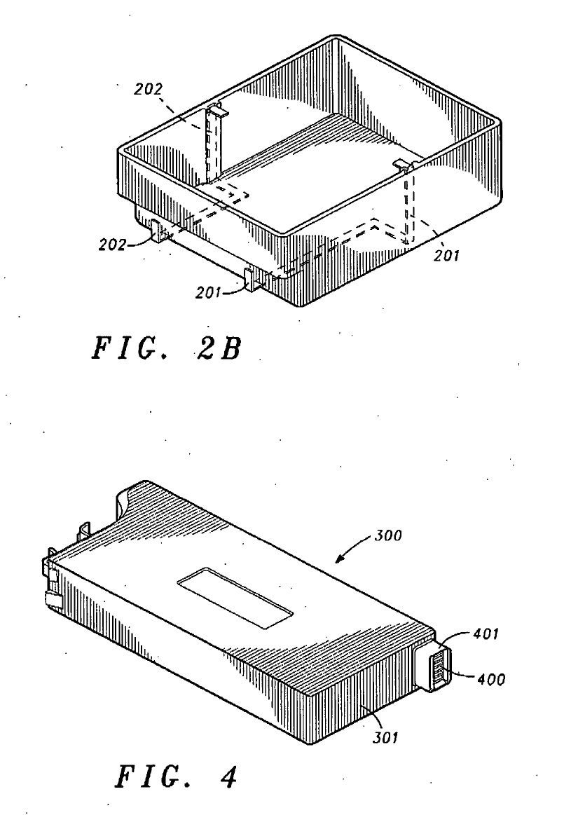

Turning now to FIGS. 2A and 2B, illustrated therein is a completed battery module 200 and a battery module housing, respectively. In these views, the battery module housing is shown as transparent, such that the internal connections of the pack may be more easily seen. Each of the components from FIG. 1, including the circuit assembly 101 and connector 106, the cells 102 and housing 100, may all be seen.

One of the primary advantages of the modular design of this invention is that each battery module 200 ensures that the circuit compartment 105 is impenetrable to liquids present in the cell compartment 104. This hermetic sealing of the circuit compartment 105 with respect to the cell compartment 104 is primarily achieved by insert molding and ultrasonic welding, as described in the following paragraphs.

The plurality of cells 102, which in this exemplary embodiment includes nine cells, is coupled to the battery module circuit assembly 101 by metal tabs 201,202. The metal tabs 201,202 are insert molded into the battery module housing 100. When the plastic battery module housing 100 is manufactured, tabs 201,202 are inserted into the mold prior to the injection of plastic. As such, the tabs 201,202 become integral members of the housing 100. Further, the plastic that is filled into the mold about the tabs 201,202 forms a liquid-impenetrable seal about the tabs 201,202. As such, the battery module housing 100 provides an electrical connection between the cell compartment 104 and the circuit compartment 105, without providing a channel for liquids to pass between these compartments. Thus, if one of the cells 102 were to malfunction and leak, the battery module 200 ensures that the electrolyte would not compromise the reliability of the electronic circuitry both in the battery module and in the host device.

The other aspect of the hermetic seal is the coupling of the lid 103 to the battery module housing 100. As noted above, when an ultrasonic weld is used to attach the lid 103 to the housing 100, the connection formed is equally liquid impenetrable. The combination of insert molding tabs 201,202 and ultrasonically welding the lid 103 to the battery module housing 100 makes the cell compartment 104 liquid impermeable.

Turning now to FIG. 3, illustrated therein is an exploded view of a modular battery pack 300 in accordance with the invention. The modular battery pack 300 includes a main housing 301 that has a plurality of compartments 305-307, each for accommodating a battery module 200,308,309. In this exemplary embodiment, the pack 300 includes three battery modules 200,308,309. The modular battery pack 300 also includes a main circuit compartment 304 that houses a main circuit assembly 302 which may be, for example, a printed circuit board.

The main circuit assembly 302, like the battery module circuit assembly, may include circuitry selected from the group consisting of safety circuits, charging circuits and fuel gauging circuits. The main circuit assembly 302 includes a battery module connector 310 for coupling to the electrical connectors of the battery modules 200,308,309.

A lid 303 couples to the main housing 301. The lid 303 can couple to the housing in any of a variety of ways, including ultrasonic welding, gluing, snaps and screws. As noted above, however, one of the advantages of the modular pack 300 is that each of the components may be shipped in compliance with IATA guidelines. As such, for ease of assembly on the site, attachment methods like screws and snaps are often preferred.

Turning now to FIG. 4, illustrated therein is a completed, assembled modular battery pack 300 in accordance with the invention. The modular battery pack 300 includes a main connector 400 that is used to couple the pack 300 to an electronic device. The main connector is coupled to the main circuit assembly (element 302 of FIG. 3), and protrudes through a main connector aperture 401 located in the modular battery pack housing.

The modular battery pack of this invention has several advantages over the prior art of either shipping cells individually and having a technician assemble the pack on site, or paying premium fees to ship the battery pack as a “dangerous good” item. To begin, the battery modules within the pack serve to divide the plurality of cells individual cell banks within each module. As noted above, this allows the modular pack to be shipped in compliance with standard IATA shipping regulations.

Second, the fact that cells are hermetically sealed within the cell compartment of the battery module protects electronic components and associated circuitry on either the battery module circuit assembly or the main circuit assembly from being compromised in the event that electrolyte leaks from any one of the cells.

Third, the use of ultrasonic welding and insert molding with respect to the battery modules provides a liquid-impermeable seal about the cells.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

What is claimed is:

1. A modular battery pack, comprising:
a. a main housing, comprising:
i. at least one compartment for accommodating a battery module;
ii. at least one main circuit assembly comprising at least one battery module connector; and
b. a plurality of battery modules, each battery module comprising:
i. a battery module housing having a cell compartment and a circuit compartment;
ii. a plurality of rechargeable cells disposed within the cell compartment;
iii. a battery module circuit assembly disposed within the circuit compartment;
iv. at least one tab electrically coupling the plurality of rechargeable cells with the battery module circuit assembly;
wherein the at least one tab is insert molded into the modular compartment.

2. The pack of claim 1, wherein the circuit compartment is impenetrable to liquids present in the cell compartment.

3. The pack of claim 2, wherein at least one of the main circuit assembly and the battery module circuit assembly comprises a circuit selected from the group consisting of safety circuits, charging circuits and fuel gauging circuits.

4. The pack of claim 2, wherein the plurality of rechargeable cells comprises nine lithium cells.

5. The pack of claim 2, wherein the battery module circuit assembly comprises an electrical connector capable of coupling to the at least one battery module connector.

6. The pack of claim 5, wherein the plurality of battery modules comprises three battery modules.

7. The pack of claim 5, further comprising a main housing lid, wherein the main housing lid is coupled to the main housing by a method selected from the group consisting of ultrasonic welding, gluing, snaps and screws.

8. The pack of claim 5, further comprising a circuit cap, wherein the circuit cap is coupled to the main housing by a method selected from the group consisting of ultrasonic welding, gluing, snaps and screws.

9. A modular battery pack, comprising:
a. a main housing, comprising:
i. a plurality of battery module compartments;
ii. a main printed circuit board having a plurality of battery module connectors; and
b. a plurality of battery modules, each battery module comprising:
i. a battery module housing having a cell compartment and a circuit compartment;
ii. a plurality of rechargeable cells disposed within the cell compartment;
iii. a battery module printed circuit board disposed within the circuit compartment;
iv. a pair of tabs electrically coupling the plurality of rechargeable cells with the battery module printed circuit board;
wherein the at least one tab is insert molded into the modular compartment;
further wherein the circuit compartment is hermetically sealed with respect to the cell compartment.

10. The pack of claim 9, wherein at least one of the main printed circuit board and the battery module printed circuit board comprises a circuit selected from the group consisting of safety circuits, charging circuits and fuel gauging circuits.

11. The pack of claim 10, wherein the plurality of rechargeable cells comprises nine lithium cells.

12. The pack of claim 9, wherein the battery module printed circuit board comprises an electrical connector capable of coupling to at least one of battery module connectors.

13. The pack of claim 12, wherein the plurality of battery modules comprises three battery modules.

14. The pack of claim 4, further comprising a main housing lid, wherein the main housing lid is coupled to the main housing by a method selected from the group consisting of ultrasonic welding, gluing, snaps and screws.
